(19) United States
(12) Patent Application Publication
(10) Pub. No.: US 2023/0271459 A1
(43) Pub. Date: Aug. 31, 2023

(54) PNEUMATIC TIRE

(71) Applicant: The Yokohama Rubber Co., LTD., Tokyo (JP)

(72) Inventors: Yuki NAGAHASHI, Kanagawa (JP); Masahiro NARUSE, Kanagawa (JP)

(21) Appl. No.: 18/002,885

(22) PCT Filed: Jun. 22, 2021
(86) PCT No.: PCT/JP2021/023533

§ 371 Date: Dec. 22, 2022

(30) Foreign Application Priority Data
Jun. 29, 2020 (JP) 2020-111375

(51) Int. Cl. B60C 15/06; B60C 19/00

(52) U.S. Cl. CPC B60C 15/0603; B60C 19/00

(57) ABSTRACT

Included in a pneumatic tire are a tread extending in a circumferential direction and having an annular shape, sidewalls disposed on both sides of the tread, and beads disposed on an inner side of the sidewalls in a radial direction. A bead filler is disposed on an outer circumference of a bead core of each of the beads, a carcass layer is mounted between the beads, a reinforcing layer formed of an organic fiber cord is adjacent to an outer side of the bead filler in a width direction, a height of an upper end of the reinforcing layer is equal to or greater than a height of an upper end of the bead filler, and a transponderis between a position of an outer side in the radial direction by 15 mm from an upper end of the bead core and the upper end of the reinforcing layer.

### TECHNICAL FIELD

The present technology relates to a pneumatic tire in which a transponder is embedded and relates particularly to a pneumatic tire that can provide improved steering stability of the tire and ensured communication performance and durability of the transponder.

### BACKGROUND ART

For pneumatic tires, embedding an RFID (radio frequency identification) tag (transponder) in a tire has been proposed (see, for example, Japan Unexamined Patent Publication No. H07-137510 A). In a case where a transponder is embedded in a tire and a reinforcing layer formed of a metal member (for example, a steel cord) is disposed on a side of a bead filler to reinforce a bead portion, the displacement of the reinforcing layer blocks radio waves of the transponder, degrading the communication performance of the 20 transponder. Further, in a case where the transponder is disposed between the reinforcing layer and a carcass layer, a carcass line in the carcass layer may be misaligned, degrading the steering stability of the tire. Furthermore, the communication performance and the durability of the transponder may be degraded depending on the position of the transponder in a tire radial direction.

### SUMMARY

The present technology provides a pneumatic tire that can provide improved steering stability of the tire and ensured communication performance and durability of a transponder.

A pneumatic tire according to an embodiment of the present technology includes a tread portion extending in a tire circumferential direction and having an annular shape, a pair of sidewall portions respectively disposed on both sides of the tread portion, and a pair of bead portions each disposed on an inner side of the sidewall portions in a tire radial direction. A bead filler is disposed on an outer circumference of a bead core of each of the bead portions, a carcass layer is mounted between the pair of bead portions, an innerliner layer is disposed at an inner surface of the tire along the carcass layer, and the carcass layer is turned up from a tire inner side to a tire outer side around the bead core. In the pneumatic tire, a reinforcing layer formed of an organic fiber cord is disposed adjacent to an outer side of the bead filler in a tire width direction, a height of an upper end of the reinforcing layer is equal to or greater than a height of an upper end of the bead filler, and a transponder is disposed between a position of an outer side in the tire radial direction by 15 mm from an upper end of the bead core and the upper end of the reinforcing layer.

In an embodiment of the present technology, the reinforcing layer formed of an organic fiber cord is disposed adjacent to an outer side of the bead filler in the tire width direction, the height of the upper end of the reinforcing layer is equal to or greater than the height of the upper end of the bead filler. This can sufficiently achieve a reinforcing effect due to the reinforcing layer and improve the steering stability of the tire. Further, the reinforcing layer, which is formed of an organic fiber cord, does not block radio waves of the transponder, and thus the communication performance around the transponder can be ensured. Accordingly, the communication performance of the transponder can be improved. Furthermore, by disposing the transponder at a position in the tire radial direction as described above, the communication performance and the durability of the transponder can be sufficiently ensured.

In a pneumatic tire according to an embodiment of the present technology, an end of a turned-up portion of the carcass layer is preferably disposed on an outer side in the tire radial direction by 5 mm or more away from the upper end of the reinforcing layer. This can ensure a sufficient distance in the tire radial direction between the end of the turned-up portion of the carcass layer and the transponder, and thus the durability of the transponder can be effectively improved. At this time, even when the transponder is disposed on an inner side or an outer side of the carcass layer in the tire width direction, the radio waves of the transponder are not blocked, and the communication performance around the transponder can be ensured.

The transponder is preferably disposed between the carcass layer and a rubber layer disposed in the sidewall portions and on an outer side of the carcass layer and is in contact with the rubber layer. Accordingly, the steering stability of the tire is not deteriorated, and the communication performance and the durability of the transponder can be effectively improved.

Preferably, the transponder is disposed between the carcass layer and the innerliner layer. Accordingly, the transponder can be prevented from being damaged due to damage to the sidewall portion.

The center of the transponder is preferably disposed 10 mm or more away from a splice portion of a tire component in the tire circumferential direction. Accordingly, tire durability can be effectively improved.

The tension of an organic fiber cord constituting the reinforcing layer at 2.0% elongation is preferably within a range of from 300 N/50 mm to 6000 N/50 mm. Accordingly, the reinforcing effect of the reinforcing layer with respect to the bead portion can be increased and the steering stability of the tire can be effectively improved.

The total fineness of an organic fiber cord constituting the reinforcing layer is preferably within a range of from 500 dtex to 5000 dtex. Accordingly, the reinforcing effect of the reinforcing layer with respect to the bead portion can be increased and the steering stability of the tire can be effectively improved.

Preferably, the transponder is covered with a coating layer formed of elastomer or rubber, and the coating layer has a relative dielectric constant of 7 or less. Accordingly, the transponder is protected by the coating layer, allowing the durability of the transponder to be improved and also ensuring radio wave transmittivity of the transponder to allow the communication performance of the transponder to be effectively improved.

The total thickness Gac of the coating layer and the maximum thickness Gar of the transponder preferably satisfy the relationship 1.1≤Gac/Gar≤3.0. Accordingly, the communication distance of the transponder can be sufficiently ensured.

Preferably, the transponder includes a substrate and antennas extending from both ends of the substrate, the transponder extends along the tire circumferential direction, and a distance L between an end of the antenna in the tire circumferential direction and an end of the coating layer in the tire circumferential direction ranges from 2 mm to 20 mm. Accordingly, the communication distance of the transponder can be sufficiently ensured.

Preferably, the transponder includes a substrate and antennas extending from both ends of the substrate, and the antennas extend within a range of ±20° with respect to the tire circumferential direction. Thus, the durability of the transponder can be sufficiently ensured.

Preferably, the center of the transponder in a thickness direction is disposed within a range from 25% to 75% of the total thickness Gac of the coating layer from a surface on one side of the coating layer in a thickness direction. Accordingly, the communication distance of the transponder can be sufficiently ensured.

### BRIEF DESCRIPTION OF DRAWINGS

FIG. 1 is a meridian cross-sectional view illustrating an example of a pneumatic tire according to an embodiment of the present technology.

FIG. 2 is a meridian cross-sectional view schematically illustrating the pneumatic tire of FIG. 1.

FIGS. 3A and 3B are perspective views each illustrating a transponder that can be embedded in a pneumatic tire according to an embodiment of the present technology.

FIG. 4 is an enlarged meridian cross-sectional view illustrating a transponder embedded in the pneumatic tire of FIG. 1.

FIG. 5 is a cross-sectional view illustrating a transponder covered with a coating layer and embedded in a pneumatic tire.

FIGS. 6A to 6C are plan views each illustrating a transponder covered with a coating layer and embedded in a pneumatic tire.

FIGS. 7A and 7B are plan views each illustrating a transponder covered with a coating layer and embedded in a pneumatic tire.

FIG. 8 is an equatorial cross-sectional view schematically illustrating the pneumatic tire of FIG. 1.

FIG. 9 is a meridian cross-sectional view illustrating a pneumatic tire according to a modified example of an embodiment of the present technology.

FIG. 10 is an explanatory diagram illustrating the position of a transponder in a tire radial direction in a test tire.

### DETAILED DESCRIPTION

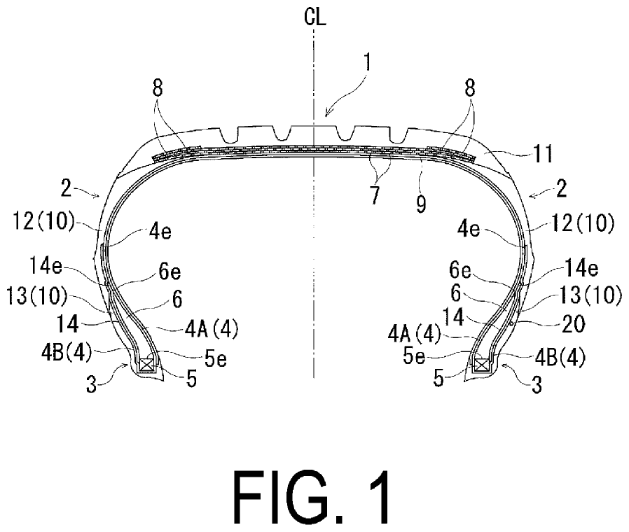

Configurations of embodiments of the present technology will be described in detail below with reference to the accompanying drawings. FIGS. 1 to 8 illustrate a pneumatic tire according to an embodiment of the present technology.

As illustrated in FIG. 1, the pneumatic tire according to the present embodiment includes a tread portion 1 extending in a tire circumferential direction and having an annular shape, a pair of sidewall portions 2 disposed on both sides of the tread portion 1, and a pair of bead portions 3 disposed on an inner side in a tire radial direction of the pair of sidewall portions 2.

At least one carcass layer 4 (one layer in FIG. 1) formed by arranging a plurality of carcass cords in the radial direction is mounted between the pair of bead portions 3. As a carcass cord constituting the carcass layer 4, an organic fiber cord such as nylon and polyester is preferably used. Bead cores 5 having an annular shape are embedded within the bead portions 3, and bead fillers 6 made of a rubber composition and having a triangular cross-section are disposed on the outer peripheries of the bead cores 5.

On the other hand, a plurality of belt layers 7 (two layers in FIG. 1) are embedded on a tire outer circumferential side of the carcass layer 4 of the tread portion 1. The belt layers 7 include a plurality of reinforcing cords that are inclined with respect to the tire circumferential direction, and the reinforcing cords are disposed between layers so as to intersect each other. In the belt layers 7, the inclination angle of the reinforcing cords with respect to the tire circumferential direction is set to fall within a range of from 10° to 40°, for example. Steel cords are preferably used as the reinforcing cords of the belt layers 7.

To improve high-speed durability, at least one belt cover layer 8 (two layers in FIG. 1) formed by arranging reinforcing cords at an angle of, for example, 5° or less with respect to the tire circumferential direction is disposed on a tire outer circumferential side of the belt layers 7. In FIG. 1, the belt cover layer 8 located on the inner side in the tire radial direction constitutes a full cover that covers the entire width of the belt layers 7, and the belt cover layer 8 located on an outer side in the tire radial direction constitutes an edge cover layer that covers only end portions of the belt layers 7. Organic fiber cords such as nylon and aramid are preferably used as the reinforcing cords of the belt cover layer 8.

In the pneumatic tire described above, both ends 4e of the carcass layer 4 are folded back from the tire inner side to the tire outer side around the bead cores 5 and are disposed wrapping around the bead cores 5 and the bead fillers 6. The carcass layer 4 includes a body portion 4A corresponding to a portion extending from the tread portion 1 through each of the sidewall portions 2 to each of the bead portions 3, and a turned-up portion 4B corresponding to a portion turned up around the bead core 5 at each of the bead portions 3 and extending toward each sidewall portion 2 side.

Additionally, on a tire inner surface, an innerliner layer 9 is disposed along the carcass layer 4. Furthermore, a cap tread rubber layer 11 is disposed in the tread portion 1, a sidewall rubber layer 12 is disposed in the sidewall portion 2, and a rim cushion rubber layer 13 is disposed in the bead portion 3. A rubber layer 10 disposed on the outer side of the carcass layer 4 in the sidewall portion 2 includes the sidewall rubber layer 12 and the rim cushion rubber layer 13.

Further, in order to reinforce the bead portion 3, a reinforcing layer 14 is disposed adjacent to the bead filler 6 on an outer side of the bead filler 6 in the tire width direction. The reinforcing layer 14 is formed by embedding a plurality of organic fiber cords in rubber. For example, an organic fiber cord such as nylon, polyester, and aramid can be used, and an aramid organic fiber cord is particularly preferred. The height of an upper end 14e (an end portion 14e on the outer side in the tire radial direction) of the reinforcing layer 14 is equal to or greater than the height of an upper end 6e (an end portion 6e on the outer side in the tire radial direction) of the bead filler 6. In particular, the upper end 14e of the reinforcing layer 14 is preferably disposed on the outer side in the tire radial direction by 5 mm or more away from the upper end 6e of the bead filler 6, and more preferably disposed on the outer side in the tire radial direction by 10 mm or more away from the upper end 6e of the bead filler 6.

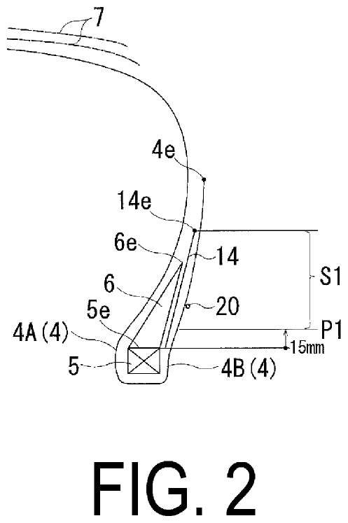

A transponder 20 is embedded between the turned-up portion 4B of the carcass layer 4 and the rubber layer 10. In other words, the transponder 20 is disposed between the turned-up portion 4B of the carcass layer 4 and the sidewall rubber layer 12 or the rim cushion rubber layer 13 as an arrangement region in the tire width direction. Additionally, as an arrangement region in the tire radial direction, the transponder 20 is disposed between a position P1 of the outer side in the tire radial direction by 15 mm from an upper end 5e of the bead core 5 (an end portion 5e on the outer side in the tire radial direction) and the upper end 14e of the reinforcing layer 14. In other words, the transponder 20 is disposed in a region S1 illustrated in FIG. 2.

Note that in the embodiment of FIGS. 1 and 2, an example has been illustrated in which the end 4e of the turned-up portion 4B of the carcass layer 4 is disposed halfway up the sidewall portion 2. However, the end 4e of the turned-up portion 4B of the carcass layer 4 can be disposed laterally to the bead core 5. In such a low turned-up structure, the transponder 20 is disposed between the reinforcing layer 14 and the sidewall rubber layer 12 or the rim cushion rubber layer 13. As another structure, the transponder 20 can be disposed between the reinforcing layer 14 and the bead filler 6.

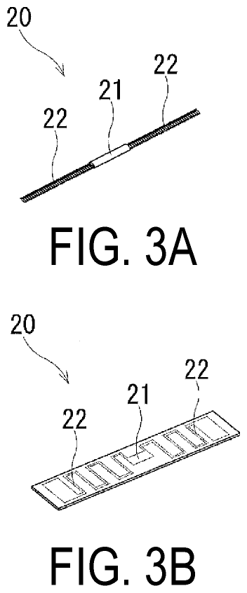

As the transponder 20, for example, a radio frequency identification (RFID) tag can be used. As illustrated in FIGS. 3A and 3B, the transponder 20 includes a substrate 21 that stores data and antennas 22 that transmit and receive data in a non-contact manner. By using the transponder 20 as described above to write or read information related to the tire on a timely basis, the tire can be efficiently managed. Note that “RFID” refers to an automatic recognition technology including: a reader/writer including an antenna and a controller; and an ID (identification) tag including a substrate and an antenna, the automatic recognition technology allowing data to be communicated in a wireless manner.

The overall shape of the transponder 20 is not limited to particular shapes and can use a pillar or plate-like shape as illustrated in, for example, FIGS. 3A and 3B. In particular, using the transponder 20 having a pillar-like shape illustrated in FIG. 3A can suitably follow the deformation of the tire in each direction. In this case, the antennas 22 of the transponder 20 each project from both end portions of the substrate 21 and exhibit a helical shape. This allows the transponder 20 to follow the deformation of the tire during traveling, allowing the durability of the transponder 20 to be improved. Additionally, by appropriately changing the length of the antenna 22, the communication performance can be ensured.

In the pneumatic tire described above, since the reinforcing layer 14 formed of an organic fiber cord is disposed adjacent to the outer side of the bead filler 6 in the tire width direction, and the height of the upper end 14e of the reinforcing layer 14 is equal to or greater than the height of the upper end 6e of the bead filler 6, a reinforcing effect by the reinforcing layer 14 can be sufficiently achieved and the steering stability of the tire can be improved. Further, the reinforcing layer 14, which is formed of an organic fiber cord, does not block radio waves of the transponder 20, and thus the communication performance around the transponder 20 can be ensured. Accordingly, the communication performance of the transponder 20 can be improved. Furthermore, the transponder 20 is disposed between the position P1 of the outer side in the tire radial direction by 15 mm from the upper end 5e of the bead core 5 and the upper end 14e of the reinforcing layer 14, and the communication performance and the durability of the transponder 20 can be sufficiently ensured.

In the pneumatic tire described above, the end 4e of the turned-up portion 4B of the carcass layer 4 is preferably disposed on the outer side in the tire radial direction by 5 mm or more away from the upper end 14e of the reinforcing layer 14. Here, in a case where there is a plurality of carcass layers 4 (for example, two carcass layers 4), the end 4e of the turned-up portion 4B of at least one carcass layer 4 is disposed on the outer side in the tire radial direction by 5 mm or more away from the upper end 14e of the reinforcing layer 14. By disposing the end 4e of the turned-up portion 4B of the carcass layer 4 as described above, it is possible to ensure a sufficient distance in the tire radial direction between the end 4e of the turned-up portion 4B of the carcass layer 4 and the transponder 20, and thus the durability of the transponder 20 can be effectively improved. At this time, even when the transponder 20 is disposed on the inner side or the outer side of the carcass layer 4 in the tire width direction, the radio waves of the transponder 20 are not blocked, and the communication performance around the transponder 20 can be ensured.

In addition, the transponder 20 is preferably disposed between the carcass layer 4 and the rubber layer 10 disposed in the sidewall portions 2 and on the outer side of the carcass layer 4 and is in contact with the rubber layer 10. By disposing the transponder 20 as described above, the steering stability of the tire is not deteriorated, and the communication performance and the durability of the transponder 20 can be effectively improved.

In the pneumatic tire described above, the tension of an organic fiber cord constituting the reinforcing layer 14 at 2.0% elongation is preferably within a range from 300 N/50 mm to 6000 N/50 mm, and more preferably within a range of from 3000 N/50 mm to 5000 N/50 mm. By appropriately setting the tension of the reinforcing layer 14 as described above, the reinforcing effect of the reinforcing layer 14 with respect to the bead portion 3 can be increased and the steering stability of the tire can be effectively improved.

The total fineness of an organic fiber cord constituting the reinforcing layer 14 is preferably within a range from 500 dtex to 5000 dtex, and more preferably within a range of from 2000 dtex to 4000 dtex. By appropriately setting the total fineness of the reinforcing layer 14 as described above, the reinforcing effect of the reinforcing layer 14 with respect to the bead portion 3 can be increased and the steering stability of the tire can be effectively improved.

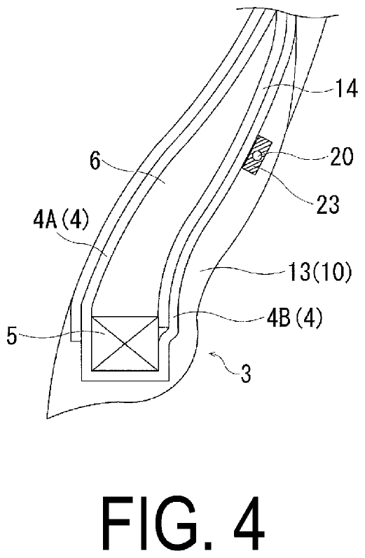

As illustrated in FIG. 4, the transponder 20 is preferably covered with a coating layer 23 formed of elastomer or rubber. The coating layer 23 coats the entire transponder 20 while holding both front and rear sides of the transponder 20. The coating layer 23 may be formed from rubber having physical properties identical to those of the rubber constituting the sidewall rubber layer 12 or the rim cushion rubber layer 13 or from rubber having different physical properties. The transponder 20 is protected by the coating layer 23 as described above, and thus the durability of the transponder 20 can be improved. Note that the cross-sectional shape of the coating layer 23 is not limited to particular shapes and can adopt, for example, a triangular shape, a rectangular shape, a trapezoidal shape, and a spindle shape.

As the composition of the coating layer 23, the coating layer 23 is preferably made of rubber or elastomer and 20 phr or more of white filler. The relative dielectric constant can be set relatively lower for the coating layer 23 configured as described above than for the coating layer 23 containing carbon, allowing the communication performance of the transponder 20 to be effectively improved. Note that “phr” as used herein means parts by weight per 100 parts by weight of the rubber component (elastomer).

The white filler constituting the coating layer 23 preferably includes from 20 phr to 55 phr of calcium carbonate. This enables a relatively low relative dielectric constant to be set for the coating layer 23, allowing the communication performance of the transponder 20 to be effectively improved. However, the white filler with an excessive amount of calcium carbonate contained is brittle, and the strength of the coating layer 23 decreases. This is not preferable. Additionally, the coating layer 23 can optionally contain, in addition to calcium carbonate, 20 phr or less of silica (white filler) or 5 phr or less of carbon black. In a case where a small amount of silica or carbon black is used with the coating layer 23, the relative dielectric constant of the coating layer 23 can be reduced while ensuring the strength of the coating layer 23.

In addition, the coating layer 23 preferably has a relative dielectric constant of 7 or less, and more preferably from 2 to 5. By properly setting the relative dielectric constant of the coating layer 23 as described above, radio wave transmittivity can be ensured during emission of a radio wave by the transponder 20, effectively improving the communication performance of the transponder 20. Note that the rubber constituting the coating layer 23 has a relative dielectric constant of from 860 MHz to 960 MHz at ambient temperature. In this regard, the ambient temperature is 23±2° C. and 60%±5% RH (relative humidity) in accordance with the standard conditions of the JIS (Japanese Industrial Standard). The relative dielectric constant of the rubber is measured after 24 hour treatment at 23° C. and 60% RH. The range from 860 MHz to 960 MHz described above corresponds to currently allocated frequencies of the RFID in a UHF (ultra-high frequency) band, but in a case where the allocated frequencies are changed, the relative dielectric constant in the range of the allocated frequencies may be specified as described above.

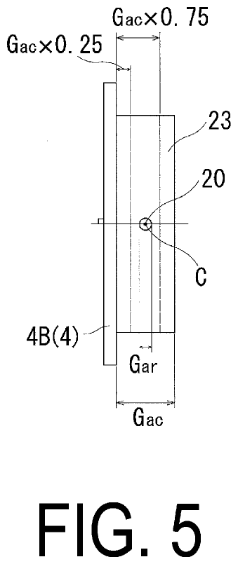

In the pneumatic tire described above, the total thickness Gac of the coating layer 23 and the maximum thickness Gar of the transponder 20 preferably satisfy the relationship 1.1≤Gac/Gar≤3.0. Here, the total thickness Gac of the coating layer 23 is the total thickness of the coating layer 23 at a position including the transponder 20, and is, for example, as illustrated in FIG. 5, the total thickness on a straight line passing through the center C of the transponder 20 and perpendicularly intersecting the closest carcass cord of the carcass layer 4 in a tire meridian cross-section.

As described above, appropriately setting the ratio of the total thickness Gac of the coating layer 23 to the maximum thickness Gar of the transponder 20 can sufficiently ensure the communication distance of the transponder 20. Here, when the above-described ratio is excessively small (the total thickness Gac of the coating layer 23 is excessively thin), the transponder 20 comes into contact with an adjacent rubber member, resonant frequency is shifted, and the communication performance of the transponder 20 is degraded. On the other hand, when the above-described ratio is excessively large (the total thickness Gac of the coating layer 23 is excessively thick), the tire durability tends to be degraded.

As illustrated in FIG. 5, in the pneumatic tire described above, the center C of the transponder 20 in a thickness direction is preferably disposed within a range of from 25% to 75% of the total thickness Gac of the coating layer 23 from a surface on one side in a thickness direction of the coating layer 23. Accordingly, the transponder 20 is securely covered with the coating layer 23, and thus the surrounding environment of the transponder 20 becomes stable and the communication distance of the transponder 20 can be sufficiently ensured without causing the shifting of the resonant frequency.

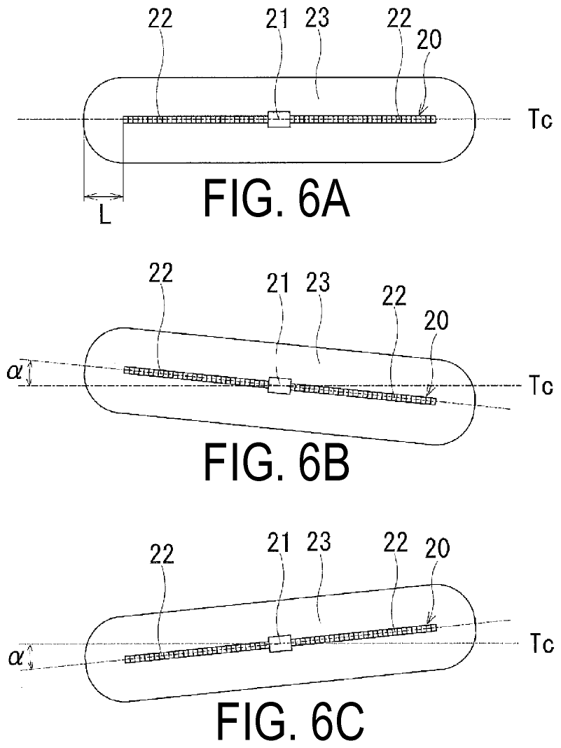

As illustrated in FIGS. 6A to 6C, in the pneumatic tire described above, preferably, the transponder 20 includes the substrate 21 and the antennas 22 extending from both ends of the substrate 21, and the transponder 20 extends along the tire circumferential direction Tc. More specifically, an inclination angle α of the transponder 20 with respect to the tire circumferential direction is preferably within a range of ±20°. Also, a distance L between an end of the antenna 22 in the tire circumferential direction and an end of the coating layer 23 in the tire circumferential direction preferably ranges from 2 mm to 20 mm. Accordingly, the transponder 20 is completely and securely covered with the coating layer 23, and thus the communication distance of the transponder 20 can be sufficiently ensured.

Here, when the absolute value of the inclination angle α of the transponder 20 with respect to the tire circumferential direction Tc is greater than 20°, the durability of the transponder 20 against repeated deformation of the tire during travel is degraded. Also, when the distance L between the end of the antenna 22 in the tire circumferential direction and the end of the coating layer 23 in the tire circumferential direction is less than 2 mm, there is a concern that the end of the antenna 22 in the tire circumferential direction may protrude from the coating layer 23, the antenna 22 may be damaged during travel, and the communication distance after travel may be reduced. On the other hand, when the distance L is greater than 20 mm, a local increase in weight occurs on the tire circumference, causing deterioration in tire balance.

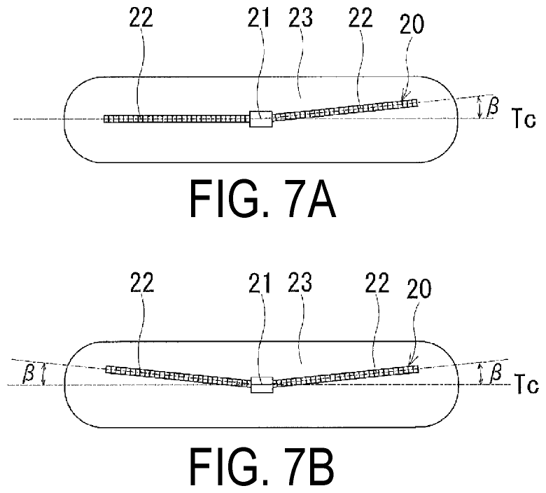

As illustrated in FIGS. 7A and 7B, in the pneumatic tire described above, the transponder 20 includes the substrate 21 and the antennas 22 extending from both ends of the substrate 21, and at least one of the antennas 22 may extend so as to bend with respect to the substrate 21. In this case, an angle β of each antenna 22 with respect to the tire circumferential direction Tc is preferably within a range of ±20°. By regulating the inclination of the antennas 22 constituting the transponder 20 as described above, the durability of the transponder 20 can be sufficiently ensured.

Here, when the absolute value of the inclination angle β of the transponder 20 with respect to the tire circumferential direction Tc is greater than 20°, stress concentrates on a base end portion of the antenna 22 due to repeated deformation of the tire during travel and thus the durability of the transponder 20 is degraded. Note that, the antenna 22 is not necessarily a straight line, and the inclination angle β of the antenna 22 is an angle formed by a straight line connecting the base end and the tip of the antenna 22 with respect to the tire circumferential direction.

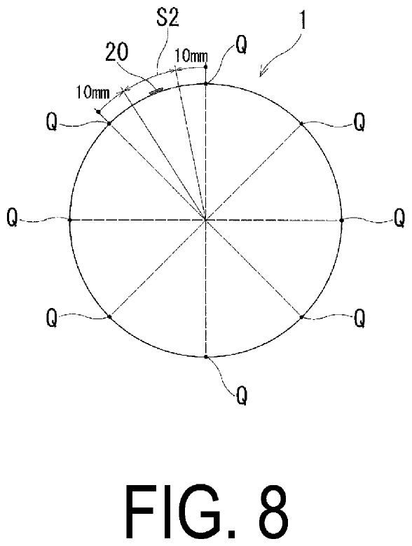

As illustrated in FIG. 8, a plurality of splice portions formed by overlaying end portions of the tire component are present on the tire circumference. FIG. 8 illustrates a position Q of each splice portion in the tire circumferential direction. The center of the transponder 20 is preferably disposed 10 mm or more away from the splice portion of the tire component in the tire circumferential direction. In other words, the transponder 20 is preferably disposed in a region S2 illustrated in FIG. 8. Specifically, the substrate 21 constituting the transponder 20 is preferably located 10 mm or more away from the position Q in the tire circumferential direction. Furthermore, the entire transponder 20 including the antenna 22 is more preferably located 10 mm or more away from the position Q in the tire circumferential direction, and the entire transponder 20 covered with the coating rubber is most preferably located 10 mm or more away from the position Q in the tire circumferential direction. In addition, the tire component in which the splice portion is disposed away from the transponder 20 is preferably a member adjacent to the transponder 20. Examples of such a tire component include the carcass layer 4, the sidewall rubber layer 12, the rim cushion rubber layer 13, and the reinforcing layer 14. Disposing the transponder 20 away from the splice portion of the tire component as described above can effectively improve tire durability.

Note that the embodiment of FIG. 8 illustrates an example in which the position Q of the splice portion of each tire component in the tire circumferential direction is disposed at equal intervals, but no such limitation is intended. The position Q in the tire circumferential direction can be set at any position, and in either case, the transponder 20 is disposed 10 mm or more away from the splice portion of each tire component in the tire circumferential direction.

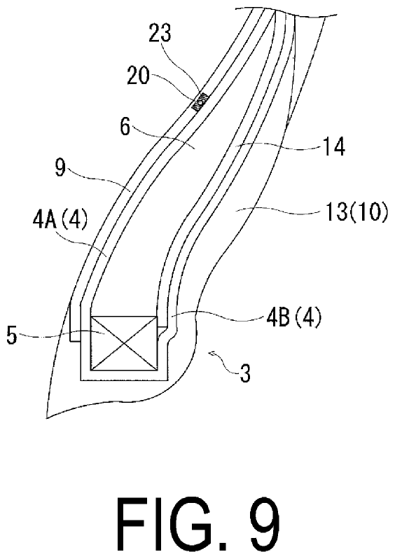

FIG. 9 illustrates a modified example of a pneumatic tire according to an embodiment of the present technology. In FIG. 9, components that are identical to those in FIGS. 1 to 8 have the same reference signs, and detailed descriptions of those components are omitted.

As illustrated in FIG. 9, the transponder 20 is disposed between the carcass layer 4 and the innerliner layer 9. Disposing the transponder 20 as described above can prevent the transponder 20 from being damaged due to damage of the sidewall portion 2. In addition, the tire component whose splice portions S are disposed away from the transponder 20 is preferably a member adjacent to the transponder 20. Examples of such a tire component include the carcass layer 4 and the innerliner layer 9. Disposing the transponder 20 away from the splice portions of the tire component as described above can effectively improve tire durability.

### EXAMPLES

Tires according to Comparative Examples 1 to 4 and Examples 1 to 15 were manufactured. Pneumatic tires have a tire size of 235/60R18 and include a tread portion extending in the tire circumferential direction and having an annular shape, a pair of sidewall portions respectively disposed on both sides of the tread portion, and a pair of bead portions each disposed on an inner side of the sidewall portions in the tire radial direction. A bead filler is disposed on an outer circumference of a bead core of each of the bead portions, a carcass layer is mounted between the pair of bead portions, an innerliner layer is disposed at an inner surface of the tire along the carcass layer, and the carcass layer is turned up from the tire inner side to the tire outer side around the bead core. In the pneumatic tires, a transponder is embedded, and the position of the transponder (tire width direction, tire radial direction, and tire circumferential direction), a reinforcing layer (constituent material, upper end position, tension, and total fineness), an end position of a turned-up portion of the carcass layer, a coating layer (constituent material, relative dielectric constant, and Gac/Gar) are set as shown in Tables 1 and 2.

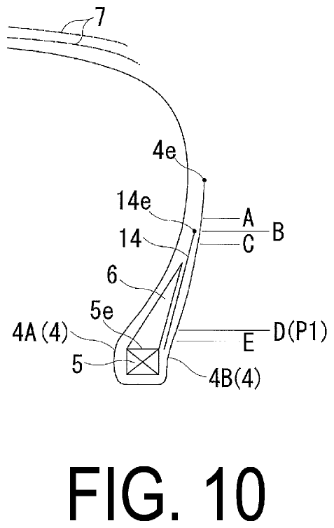

Note that, in Tables 1 and 2, the position “X” of the transponder (tire width direction) indicates that the transponder is disposed between the carcass layer and the sidewall rubber layer in contact with the sidewall rubber layer, the position “Y” of the transponder (tire width direction) indicates that the transponderis disposed between the carcass layer and the rim cushion rubber layer in contact with the rim cushion rubber layer, and the position “Z” of the transponder (tire width direction) indicates that the transponder is disposed between the carcass layer and the innerliner layer. The position of the transponder (tire radial direction) corresponds to each of the positions A to E illustrated in FIG. 10. The position of the transponder (tire circumferential direction) indicates the distance (mm) measured from the center of the transponder to the splice portion of the tire component in the tire circumferential direction. Also, in Tables 1 and 2, the upper end position of the reinforcing layer indicates a distance (mm) measured in the tire radial direction from the upper end of the bead filler as a base point, and the end position of the turned-up portion of the carcass layer indicates a distance (mm) measured in the tire radial direction from the upper end of the reinforcing layer as a base point. A positive value means that the upper end is located on the outer side of the base point in the tire radial direction, and a negative value means that the upper end is located on the inner side of the base point in the tire radial direction.

For the tire of Comparative Example 1 that does not include a reinforcing layer, since the end position of the turned-up portion of the carcass layer in the tire of Comparative Example 1 is set at the same height as that in the tire of Example 1, the same value as a value in the tire of Example 1 is indicated for the sake of convenience.

Tire evaluation (steering stability and durability) and transponder evaluation (communication performance and durability) were conducted on the test tires using a test method described below, and the results are shown in Tables 1 and 2.

Steering Stability (Tire):

Each test tire was mounted on a wheel with a standard rim, the wheel was mounted on a test vehicle, and sensory evaluation by a test driver was conducted on a test course. The evaluation results are expressed as three levels: “Excellent” indicates that the result is very good, “Good” indicates that the result is good, and “Fair” indicates that the result is slightly inferior.

Durability (Tire and Transponder):

Each of the test tires was mounted on a wheel of a standard rim, and a traveling test was performed by using a drum testing machine at an air pressure of 120 kPa, a maximum load of 102%, and a traveling speed of 81 km/h, and the traveling distance at the time of a failure in the tire was measured. Evaluation results are expressed in three levels: “Excellent” indicates that the traveling distance reached 6480 km, “Good” indicates that the traveling distance was 4050 km or more and less than 6480 km, “Fair” indicates that the traveling distance was less than 4050 km. Further, upon completion of the traveling, the transponder embedded in each test tire was checked for the presence of breakage, and the presence of breakage is indicated as the evaluation result.

Communication Performance (Transponder):

For each test tire, a communication operation with the transponder was performed using a reader/writer. Specifically, the maximum communication distance was measured with the reader/writer at a power output of 250 mW and a carrier frequency of from 860 MHz to 960 MHz. The evaluation results are expressed in three levels: “Excellent” indicates that the communication distance is 1000 mm or more, “Good” indicates that the communication distance is 500 mm or more and less than 1000 mm, and “Fair” indicates that the communication distance is less than 500 mm.

TABLE 1

| | | Comparative | Comparative | Comparative |
|---|---|---|---|---|
| | | Example 1 | Example 2 | Example 3 |
| Position of | Tire width direction | Y | X | X |
| transponder | Tire radial direction | E | B | B |
| | Tire circumferential | 10 | 10 | 10 |
| | direction (mm) | | | |
| Reinforcing | Constituent material | — | Metal | Organic |
| layer | | | | fiber |
| | Upper end position | — | 10 | −5 |
| | (mm) | | | |
| | Tension (N/50 mm) | — | 2000 | 2000 |
| | Total fineness (dtex) | — | 1000 | 1000 |
| End position of turned-up | | 5 | 5 | 5 |
| portion of carcass layer (mm} | | | | |
| Coating | Constituent material | — | — | — |
| layer | Relative dielectric | — | — | — |
| | constant | | | |
| | Gac/Gar | — | — | — |
| Tire evaluation | Steering stability | Fair | Excellent | Fair |
| | Durability | Good | Excellent | Excellent |
| Transponder | Communication | Fair | Fair | Good |
| evaluation | performance | | | |
| | Durability (presence | No | No | No |
| | of breakage) | | | |

| | | Comparative | | |
|---|---|---|---|---|
| | | Example 4 | Example 1 | Example 2 |
| Position of | Tire width direction | X | X | Y |
| transponder | Tire radial direction | A | B | D |
| | Tire circumferential | 10 | 10 | 10 |
| | direction (mm) | | | |
| Reinforcing | Constituent material | Organic | Organic | Organic |
| layer | | fiber | fiber | fiber |
| | Upper end position | 10 | 10 | 10 |
| | (mm) | | | |
| | Tension (N/50 mm) | 2000 | 2000 | 2000 |
| | Total fineness (dtex) | 1000 | 1000 | 1000 |
| End position of turned-up | | 5 | 5 | 5 |
| portion of carcass layer (mm) | | | | |
| Coating | Constituent material | — | — | — |
| layer | Relative dielectric | — | — | — |
| | constant | | | |
| | Gac/Gar | — | — | — |
| Tire evaluation | Steering stability | Good | Good | Good |
| | Durability | Excellent | Excellent | Excellent |
| Transponder | Communication | Good | Good | Good |
| evaluation | performance | | | |
| | Durability (presence | Yes | No | No |
| | of breakage) | | | |

| | | Example 3 | Example 4 | Example 5 | Example 6 |
|---|---|---|---|---|---|
| Position of | Tire width direction | X | Y | Z | Z |
| transponder | Tire radial direction | C | C | C | C |
| | Tire circumferential | 10 | 10 | 10 | 5 |
| | direction (mm) | | | | |
| Reinforcing | Constituent material | Organic | Organic | Organic | Organic |
| layer | | fiber | fiber | fiber | fiber |
| | Upper end position | 10 | 10 | 10 | 10 |
| | (mm) | | | | |
| | Tension (N/50 mm) | 2000 | 2000 | 2000 | 2000 |
| | Total fineness (dtex) | 1000 | 1000 | 1000 | 1000 |
| End position of turned-up | | 5 | 5 | 5 | 5 |
| portion of carcass layer (mm) | | | | | |
| Coating | Constituent material | — | — | — | — |
| layer | Relative dielectric | — | — | — | — |
| | constant | | | | |
| | Gac/Gar | — | — | — | — |
| Tire evaluation | Steering stability | Good | Good | Good | Good |
| | Durability | Excellent | Excellent | Excellent | Good |
| Transponder | Communication | Good | Good | Good | Good |
| evaluation | performance | | | | |
| | Durability (presence | Yes | No | No | No |
| | of breakage) | | | | |

TABLE 2

| | | Exam- | Exam- | Exam- |
|---|---|---|---|---|
| | | ple 7 | ple 8 | ple 9 |
| Position of | Tire width direction | X | X | X |
| transponder | Tire radial direction | C | C | C |
| | Tire circumferential | 10 | 10 | 10 |
| | direction (mm) | | | |
| Reinforcing | Constituent material | Organic | Organic | Organic |
| layer | | fiber | fiber | fiber |
| | Upper end position | 10 | 10 | 10 |
| | (mm) | | | |
| | Tension (N/50 mm) | 4000 | 4000 | 4000 |
| | Total fineness (dtex) | 3000 | 3000 | 3000 |
| End position of turned-up | | 5 | 5 | 5 |
| portion of carcass layer (mm) | | | | |
| Coating | Constituent material | — | Resin | Rubber |
| layer | Relative dielectric | — | 7 | 3.5 |
| | constant | | | |
| | Gac/Gar | — | 2.0 | 2.0 |
| Tire evaluation | Steering stability | Excellent | Excellent | Excellent |
| | Durability | Excellent | Good | Excellent |
| Transponder | Communication | Good | Excellent | Excellent |
| evaluation | performance | | | |
| | Durability (presence | No | No | No |
| | of breakage) | | | |
| | | Exam- | Exam- | Exam- |
| | | ple 10 | ple 11 | ple 12 |
| Position of | Tire width direction | X | X | X |
| transponder | Tire radial direction | C | C | C |
| | Tire circumferential | 10 | 10 | 10 |
| | direction (mm) | | | |
| Reinforcing | Constituent material | Organic | Organic | Organic |
| layer | | fiber | fiber | fiber |
| | Upper end position | 10 | 10 | 10 |
| | (mm) | | | |
| | Tension (N/50 mm) | 4000 | 4000 | 4000 |
| | Total fineness (dtex) | 3000 | 3000 | 3000 |
| End position of turned-up | | 5 | 5 | 5 |
| portion of carcass layer (mm) | | | | |
| Coating | Constituent material | Rubber | Rubber | Rubber |
| layer | Relative dielectric | 7 | 8 | 7 |
| | constant | | | |
| | Gac/Gar | 2.0 | 2.0 | 1.0 |
| Tire evaluation | Steering stability | Excellent | Excellent | Excellent |
| | Durability | Excellent | Excellent | Excellent |
| Transponder | Communication | Excellent | Good | Good |
| evaluation | performance | | | |
| | Durability (presence | No | No | No |
| | of breakage) | | | |
| | | Exam- | Exam- | Exam- |
| | | ple 13 | ple 14 | ple 15 |
| Position of | Tire width direction | X | X | X |
| transponder | Tire radial direction | C | C | C |
| | Tire circumferential | 10 | 10 | 10 |
| | direction (mm) | | | |
| Reinforcing | Constituent material | Organic | Organic | Organic |
| layer | | fiber | fiber | fiber |
| | Upper end position | 10 | 10 | 10 |
| | (mm) | | | |
| | Tension (N/50 mm) | 4000 | 4000 | 4000 |
| | Total fineness (dtex) | 3000 | 3000 | 3000 |
| End position of turned-up | | 5 | 5 | 5 |
| portion of carcass layer (mm) | | | | |
| Coating | Constituent material | Rubber | Rubber | Rubber |
| layer | Relative dielectric | 7 | 7 | — |
| | constant | | | |
| | Gac/Gar | 1.1 | 3.0 | 3.1 |
| Tire evaluation | Steering stability | Excellent | Excellent | Excellent |
| | Durability | Excellent | Excellent | Good |
| Transponder | Communication | Excellent | Excellent | Excellent |
| evaluation | performance | | | |
| | Durability (presence | No | No | No |
| | of breakage) | | | |

As can be seen from Tables 1 and 2, in Examples 1 to 15, the steering stability of the tire and the communication performance and the durability of the transponder were improved in a well-balanced manner. In particular, in Examples 1 to 5, 7, and 9 to 14, a sufficient effect of improving the tire durability was obtained.

On the other hand, in Comparative Example 1, the steering stability was deteriorated because the reinforcing layer was not provided, and moreover, the communication performance of the transponder was deteriorated because the transponder was deviated to an inner side in the tire radial direction from the range defined in an embodiment of the present technology. In Comparative Example 2, since the reinforcing layer was formed of a metal member, the steering stability was improved, but the communication performance of the transponder was deteriorated. In Comparative Example 3, since the upper end of the reinforcing layer was set to be lower than the bead filler, the steering stability of the tire was deteriorated. In Comparative Example 4, since the transponder was set to be higher than the upper end of the reinforcing layer, the durability of the transponder was deteriorated.

1. A pneumatic tire, comprising:
a tread portion extending in a tire circumferential direction and having an annular shape;
a pair of sidewall portions respectively disposed on both sides of the tread portion; and
a pair of bead portions each disposed on an inner side of the sidewall portions in a tire radial direction;
a bead filler being disposed on an outer circumference of a bead core of each of the bead portions,
a carcass layer being mounted between the pair of bead portions,
an innerliner layer being disposed at an inner surface of the tire along the carcass layer,
the carcass layer being turned up from a tire inner side to a tire outer side around the bead core,
a reinforcing layer formed of an organic fiber cord being disposed adjacent to an outer side of the bead filler in a tire width direction,
a height of an upper end of the reinforcing layer being equal to or greater than a height of an upper end of the bead filler, and
a transponder being disposed between a position of an outer side in the tire radial direction by 15 mm from an upper end of the bead core and the upper end of the reinforcing layer.

2. The pneumatic tire according to claim 1, wherein an end of a turned-up portion of the carcass layer is disposed on an outer side in the tire radial direction by 5 mm or more away from the upper end of the reinforcing layer.

3. The pneumatic tire according to claim 1, wherein the transponder is disposed between the carcass layer and a rubber layer disposed in the sidewall portions and on an outer side of the carcass layer and is in contact with the rubber layer.

4. The pneumatic tire according to claim 1, wherein the transponder is disposed between the carcass layer and the innerliner layer.

5. The pneumatic tire according to claim 1, wherein a center of the transponder is disposed 10 mm or more away from a splice portion of a tire component in the tire circumferential direction.

6. The pneumatic tire according to claim 1, wherein a tension of an organic fiber cord constituting the reinforcing layer at 2.0% elongation ranges from 300 N/50 mm to 6000 N/50 mm.

7. The pneumatic tire according to claim 1, wherein a total fineness of the organic fiber cord constituting the reinforcing layer ranges from 500 dtex to 5000 dtex.

8. The pneumatic tire according to claim 1, wherein the transponder is covered with a coating layer formed of elastomer or rubber, and the coating layer has a relative dielectric constant of 7 or less.

9. The pneumatic tire according to claim 8, wherein a total thickness Gac of the coating layer and a maximum thickness Gar of the transponder satisfy a relationship 1.1≤Gac/Gar≤3.0.

10. The pneumatic tire according to claim 8, wherein the transponder comprises a substrate and antennas extending from both ends of the substrate, the transponder extends along the tire circumferential direction, and a distance L between an end of the antennas in the tire circumferential direction and an end of the coating layer in the tire circumferential direction ranges from 2 mm to 20 mm.

11. The pneumatic tire according to claim 8, wherein the transponder comprises a substrate and antennas extending from both ends of the substrate, and the antennas extend within a range of ±20° with respect to the tire circumferential direction.

12. The pneumatic tire according to claim 8, wherein a center of the transponder in a thickness direction is disposed within a range of from 25% to 75% of a total thickness Gac of the coating layer from a surface on one side of the coating layer in a thickness direction.

13. The pneumatic tire according to claim 2, wherein the transponder is disposed between the carcass layer and a rubber layer disposed in the sidewall portions and on an outer side of the carcass layer and is in contact with the rubber layer.

14. The pneumatic tire according to claim 2, wherein the transponder is disposed between the carcass layer and the innerliner layer.

15. The pneumatic tire according to 14, wherein a center of the transponder is disposed 10 mm or more away from a splice portion of a tire component in the tire circumferential direction.

16. The pneumatic tire according to 15, wherein a tension of an organic fiber cord constituting the reinforcing layer at 2.0% elongation ranges from 300 N/50 mm to 6000 N/50 mm.

17. The pneumatic tire according to claim 16, wherein a total fineness of the organic fiber cord constituting the reinforcing layer ranges from 500 dtex to 5000 dtex.

18. The pneumatic tire according to claim 17, wherein the transponder is covered with a coating layer formed of elastomer or rubber, and the coating layer has a relative dielectric constant of 7 or less.

19. The pneumatic tire according to claim 18, wherein a total thickness Gac of the coating layer and a maximum thickness Gar of the transponder satisfy a relationship 1.1≤Gac/Gar≤3.0.

20. The pneumatic tire according to claim 19, wherein the transponder comprises a substrate and antennas extending from both ends of the substrate, the transponder extends along the tire circumferential direction, and a distance L between an end of the antennas in the tire circumferential direction and an end of the coating layer in the tire circumferential direction ranges from 2 mm to 20 mm.
